(19) United States
(12) Patent Application Publication
(10) Pub. No.: US 2021/0022296 A1
(43) Pub. Date: Jan. 28, 2021

(54) Work Vehicle

(71) Applicant: Yanmar Power Technology Co., Ltd., Osaka (JP)

(72) Inventor: Toshiyuki Miwa, Osaka (JP)

(73) Assignee: Yanmar Power Technology Co., Ltd., Osaka (JP)

(21) Appl. No.: 17/042,219

(22) PCT Filed: Feb. 26, 2019
(86) PCT No.: PCT/JP2019/007165

§ 371 Date: Sep. 28, 2020

(30) Foreign Application Priority Data
Mar. 30, 2018 (JP) 2018-066949

(51) Int. Cl. A01F 15/07; A01B 61/00; A01D 69/03; A01D 69/10

(52) U.S. Cl. CPC A01F 15/0705; A01B 61/00; A01F 2015/077; A01D 69/10; A01D 69/03

(57) ABSTRACT

Provided is a work vehicle capable of efficiently performing grass collecting work by decelerating a traveling machine body in a case where the size of a bale is large and a case where the pickup load of straw grass is large. The work vehicle includes a traveling machine body 1, a roll baler unit 2, a bale detection unit 31 configured to detect a size of the bale formed by the roll baler unit 2, a load detection unit 32 configured to detect a pickup load of straw grass in the roll baler unit 2, and a traveling control unit 17A capable of decelerating the traveling machine body 1 when a size of the bale is equal to or larger than a setting value B1 and when a pickup load is equal to or larger than a setting value L. A deceleration D2 is larger than a deceleration D1.

### TECHNICAL FIELD

The present invention relates to a work vehicle that performs a grass collecting work in which straw grass such as forage grass and straw scattered in a field is collected to form a roll-shaped bale.

### BACKGROUND ART

This type of work vehicle is equipped with a traveling machine body capable of traveling by drive and a roll baler unit that picks up straw grass and forms a roll-shaped bale as the traveling machine body travels. There are a type in which the traveling machine body is configured integrally with the roll baler unit (see Patent Literatures 1 and 2), a type in which the traveling machine body is configured with a tractor that is a separate body from the roll baler unit (see Patent Literatures 3, 4, and 5), and the like.

Conventionally, as such a work vehicle, there is known a work vehicle which is equipped with a bale detection unit that detects the size of a bale formed in the roll baler unit and a traveling control unit are included, and configured to execute a deceleration-on-completion control for decelerating the traveling machine body when the size of the bale detected by the bale detection unit is equal to or larger than a setting value (for example, see the main example of Patent Literature 1 or Patent Literature 3).

With this work vehicle, when a roll forming chamber of the roll baler unit has almost reached completion, the work vehicle can be automatically decelerated and the operator can be made aware that the roll forming chamber will soon complete, and it is possible to suppress the loss of straw grass and the like due to continued grass collecting work in a state where the roll baler unit has reached completion.

In addition, there is also known a work vehicle which is equipped with a load detection unit that detects the amount of straw grass transported (pickup load) in the roll baler unit and a traveling control unit are included, and configured to execute a load deceleration control for decelerating the traveling machine body when the pickup load detected by the load detection unit is equal to or larger than a setting value (see another example of Patent Literature 1 or Patent Literature 2).

With this work vehicle, it is possible to automatically decelerate the work vehicle when the pickup load is large. For example, it is possible to avoid in advance problems such as clogging of straw grass caused by exceeding the limit of the processing capacity of the roll baler unit.

### CITATION LIST

### Patent Literature

Patent Literature 1: Japanese Unexamined Utility Model Application Publication No. 61-134256

Patent Literature 2: Japanese Unexamined Patent Application Publication No. 2003-61454

Patent Literature 3: Japanese Unexamined Patent Application Publication No. 2016-67244

Patent Literature 4: U.S. Pat. No. 74,043,55

Patent Literature 5: U.S. Pat. No. 8,577,563

### DISCLOSURE OF INVENTION

### Problems to be Solved by the Invention

It is conceivable to configure a work vehicle that performs a grass collecting work so as to be able to execute both the deceleration-on-completion control based on the size of the bale and the load deceleration control based on the pickup load of straw grass, that have been described above. However, there is a difference in the work condition and situation between a case where the size of a bale is large and a case where the pickup load of straw grass is large, and even if the load deceleration control and the deceleration-on-completion control decelerate in the same way, the grass collecting work cannot be performed efficiently.

In view of this situation, the main problem of the present invention is to provide a work vehicle capable of efficiently performing a grass collecting work by decelerating a traveling machine body depending on each work condition and situation in a case where the size of a bale is large and a case where the pickup load of straw grass is large.

### Means for Solving the Problems

A first characteristic configuration of the present invention is a feature wherein a traveling machine body capable of traveling by drive, a roll baler unit configured to pick up straw grass and form a roll-shaped bale as the traveling machine body travels, a bale detection unit configured to detect a size of the bale formed by the roll baler unit, a load detection unit configured to detect a pickup load of straw grass in the roll baler unit, and a traveling control unit capable of executing, as a deceleration control of the traveling machine body, a deceleration-on-completion control to decelerate the traveling machine body when a size of the bale detected by the bale detection unit is equal to or larger than a setting value, and a load deceleration control to decelerate the traveling machine body when a pickup load detected by the load detection unit is equal to or larger than a setting value are included, and wherein a deceleration in the load deceleration control is set to be larger than the deceleration in the deceleration-on-completion control.

According to this configuration, the traveling control unit can automatically decelerate the traveling machine body as a completion preparation operation when the size of the bale detected by the bale detection unit is equal to or larger than a setting value and the roll baler unit has almost reached completion (grass collection limit). Therefore, it is also possible to suppress the loss of straw grass and the like due to continued grass collecting work in a state where the roll baler unit has reached completion. Moreover, an operator can perform a grass collecting work with high accuracy until the roll baler unit completes in a state where the traveling speed of the traveling machine body is reduced.

In addition, the traveling control unit can automatically decelerate when the pickup load detected by the load detection unit increases to be equal to or larger than a setting value, and it is possible to avoid in advance problems such as clogging of straw grass caused by exceeding the limit of the processing capacity of the roll baler unit.

Moreover, the deceleration in the load deceleration control (deceleration such as a deceleration amount and a deceleration rate) is set to be larger than the deceleration in the deceleration-on-completion control. Thus, for example, in the deceleration-on-completion control, the deceleration is performed slowly, and it is possible to prevent disturbing the operator's grass collecting work. On the other hand, in the load deceleration control, it is possible to reliably avoid sudden deceleration and problems such as clogging of straw grass in the roll baler unit. From these things, a grass collecting work can be performed efficiently.

A second characteristic configuration of the present invention is a feature wherein an operation unit of a manually operated type and a notification unit configured to give notification when the deceleration control is being executed are included, and wherein the traveling control unit is configured to stop traveling of the traveling machine body only when detecting that an operation for stopping traveling has been performed on the operation unit during the execution of the deceleration control.

According to this configuration, since the notification unit automatically gives notification during the execution of the deceleration control, the operator can recognize that the deceleration control is being executed.

In addition, during execution of the deceleration control, the traveling control unit can stop the traveling machine body only when the operator indicates the intention to stop the traveling machine body by performing the operation for stopping traveling on the operation unit. Therefore, a tractor does not stop automatically on a sloping ground or the like and safety can be improved.

A third characteristic configuration of the present invention is a feature wherein the traveling control unit starts the traveling of the traveling machine body only when detecting that an operation for starting traveling has been performed on the operation unit during stop of the traveling of the traveling machine body.

According to this configuration, during stop of the traveling of the traveling machine body, the traveling control unit can restart the traveling of the traveling machine body only when the operator indicates the intention to restart the traveling machine body by performing the operation for starting traveling on the operation unit. Therefore, it is possible to prevent a restart unexpected by the operator, and safety can be further improved.

A fourth characteristic configuration of the present invention is a feature wherein an operation unit of a manually operated type is included, and wherein the traveling control unit is configured to temporarily cancel the deceleration-on-completion control when detecting that a pickup interruption operation for interrupting pickup of the straw grass has been performed on the operation unit during the execution of the deceleration-on-completion control, and then restart the deceleration-on-completion control when detecting that a pickup start operation for starting the pickup of the straw grass has been performed on the operation unit.

According to this configuration, during the execution of the deceleration-on-completion control, the traveling control unit can temporarily cancel the deceleration-on-completion control and increase the traveling speed when the operator indicates the intention to interrupt the pickup of straw grass by performing the pickup interruption operation on the operation unit. Therefore, when ending in the middle of the deceleration-on-completion control and moving to the next work place, it is possible to quickly move to the next work place at a speed that is increased more than the speed during the deceleration-on-completion control.

After that, the traveling control unit can restart the deceleration-on-completion control and decelerate the traveling speed when the operator indicates the intention to restart the pickup of straw grass by performing the pickup start operation for starting the pickup of straw grass on the operation unit. Therefore, after quickly moving to the next work place, the grass collecting work can be restarted at an appropriate speed that has been decelerated by the deceleration-on-completion control.

A fifth characteristic configuration of the present invention is a feature wherein, as the operation unit, a forward/reverse traveling switching operation unit capable of alternatively switching a traveling type of the traveling machine body among forward traveling, stopped traveling, and reverse traveling is included, and wherein the traveling control unit cancels the deceleration-on-completion control when detecting that the operation for stopping traveling has been performed on the forward/reverse traveling switching operation unit during the execution of the deceleration-on-completion control.

According to this configuration, during the execution of the deceleration-on-completion control, when the operator performs the operation for stopping traveling by switching the forward/reverse traveling switching operation unit to stopped traveling, the traveling control unit can stop the traveling of the traveling machine body, and can further cancel the deceleration-on-completion control. Therefore, when the traveling machine body is restarted afterwards, the traveling machine body can be caused to travel without executing the deceleration-on-completion control, and can quickly move, for example, from a place where a bale cannot be discharged, such as a sloping ground, to a place where the bale can be appropriately discharged.

A sixth characteristic configuration of the present invention is a feature wherein a deceleration amount adjustment operation unit capable of adjusting a deceleration amount as the deceleration in the deceleration control is included.

According to this configuration, it is possible to adjust a deceleration amount as the deceleration in the deceleration control of the traveling machine body by an operation on the deceleration amount adjustment operation unit. Thus, for example, it is possible to adjust the deceleration amount of the deceleration-on-completion control and the deceleration amount of the load deceleration control to an appropriate amount according to the performance and condition of the roll baler unit, and to implement an appropriate deceleration control of the traveling machine body.

A seventh characteristic configuration of the present invention is a feature wherein a deceleration rate adjustment operation unit capable of adjusting a deceleration rate as the deceleration in the deceleration control is included.

According to this configuration, it is possible to adjust a deceleration rate as the deceleration in the deceleration control of the traveling machine body by an operation on the deceleration rate adjustment operation unit. Thus, for example, it is possible to adjust the deceleration rate of the deceleration-on-completion control and the deceleration rate of the load deceleration control to an appropriate rate according to the performance and condition of the roll baler unit, and to implement an appropriate deceleration control of the traveling machine body.

### BRIEF DESCRIPTION OF DRAWINGS

FIG. 1 is a side view of a tractor.

FIG. 2 is a control block diagram of a work vehicle.

FIG. 3 is a layout view around a steering section in a cabin.

FIG. 4 is a diagram illustrating a control flow when a traveling control unit executes a deceleration-on-completion control.

FIG. 5 is a diagram illustrating a control flow when a traveling control unit temporarily cancels the deceleration-on-completion control.

FIG. 6 is a diagram illustrating the relation between the size of a bale and a traveling speed.

FIG. 7 is a diagram illustrating the relation between the size of a bale and a traveling speed.

FIG. 8 is a diagram illustrating the relation between a pickup load and a traveling speed.

FIG. 9 is a diagram illustrating the relation between a pickup load and a traveling speed.

FIG. 10 is a diagram illustrating a display example of a display unit at the time of executing the deceleration-on-completion control.

FIGS. 11(a) and 11(b) are diagrams illustrating a display example of a display unit at the time of discharging a bale.

FIG. 12 is a diagram illustrating a display example of a display unit at the time of executing a load deceleration control.

FIG. 13 is a diagram illustrating a display example of the display unit.

FIG. 14 is a diagram illustrating a display example of the display unit.

### DESCRIPTION OF EMBODIMENTS

An embodiment of a work vehicle according to the present invention will be described with reference to the drawings.

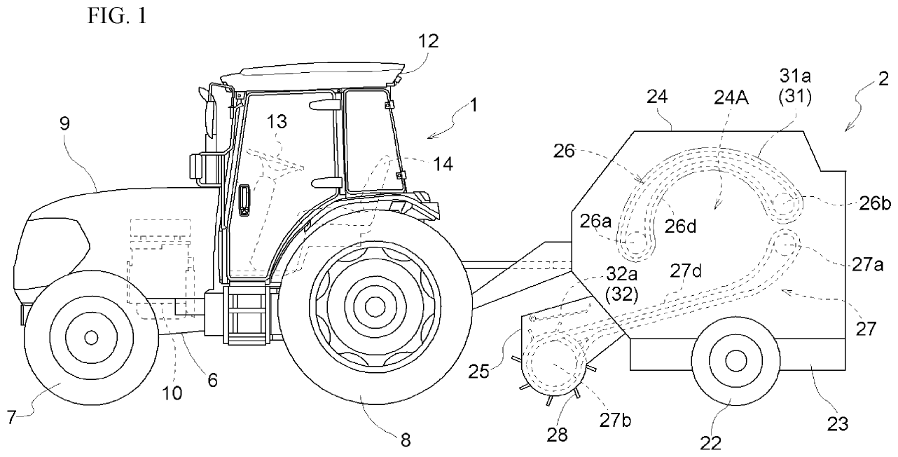

As illustrated in FIG. 1, this work vehicle includes a tractor 1 which is an example of a traveling machine body capable of traveling by drive, and a roll baler (roll baler unit) 2 that picks up straw grass and forms a roll-shaped bale as the tractor 1 travels.

The tractor 1 includes a vehicle body section 6 on the rear side, on which the roll baler 2 as a working machine can be mounted. The front portion of the vehicle body section 6 is supported by a pair of right and left front wheels 7, and the rear portion of the vehicle body section 6 is supported by a pair of right and left rear wheels 8. A bonnet 9 is disposed in the front portion of the vehicle body section 6, and an engine 10 (diesel engine) as a drive source is housed in the bonnet 9.

The rear portion of the vehicle body section 6 includes a coupling mechanism including a pair of right and left lower links and upper links, and the roll baler 2 is attached to the coupling mechanism. The rear portion of the vehicle body section 6 includes a lifting device including a hydraulic device, such as a lifting cylinder, and the lifting device can be used to lift up and down the coupling mechanism to lift up and down the roll baler 2. In addition, the rear portion of the vehicle body section 6 includes a power take-off (PTO) shaft. The driving force of the engine 10 can be transmitted to the roll baler 2 via the PTO shaft. The roll baler 2 receives the driving force from the PTO shaft of the tractor 1 and collects straw grass to form a bale.

A cabin 12 on which an operator rides is included behind the bonnet 9, and a steering section that includes a steering handle 13 and a driver's seat 14 for the operator to steer, and the like is included in the cabin 12.

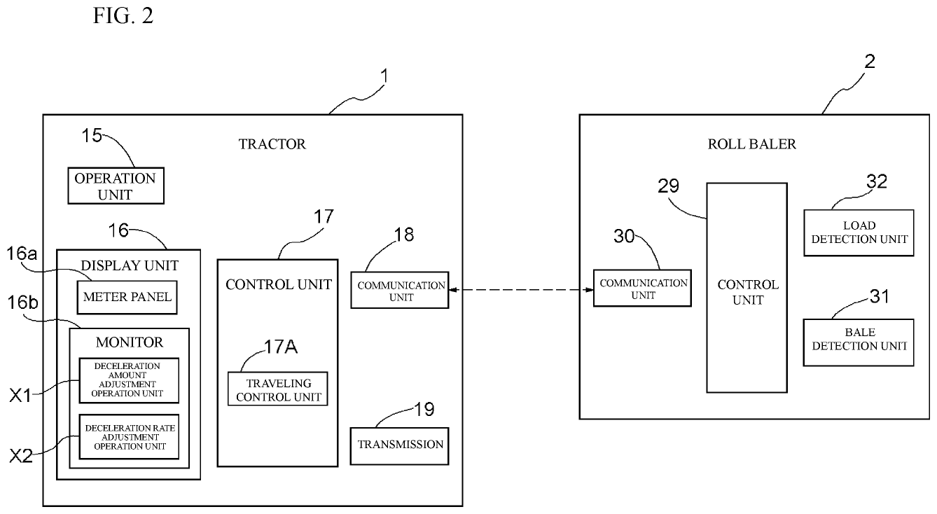

FIG. 2 is a control block diagram of the work vehicle. As illustrated in FIG. 2, the tractor 1 includes an operation unit 15 of a manually operated type that allows the operator to instruct various operations related to traveling and work, a display unit (an example of a notification unit) 16 that can display the traveling state of the tractor 1, the working state and alarm of the roll baler 2, and the like, a control unit 17 that controls various operations, a communication unit 18 that can communicate with the roll baler 2 and the outside, a transmission 19 that can change the traveling speed of the tractor 1, and the like. The transmission 19 includes, for example, a hydraulic continuously variable transmission. The control unit 17 includes a traveling control unit 17A that controls the vehicle speed of the tractor 1. The traveling control unit 17A switches the transmission state of the transmission 19 on the basis of information of the traveling state of the tractor 1 and the working state of the roll baler 2, and the like to control the vehicle speed of the tractor 1.

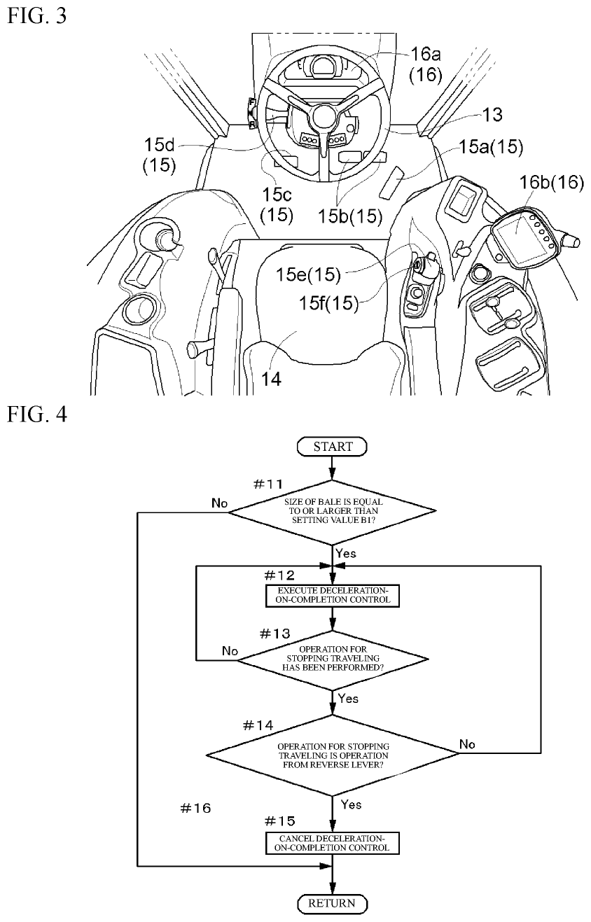

The operation unit 15 and the display unit 16 are disposed in the steering section in the cabin 12. FIG. 3 is a layout view around the steering section in the cabin 12 as seen from above. As illustrated in FIG. 3, in the front side of the driver's seat 14, included as the operation unit 15 are an accelerator pedal 15a for operating the rotation speed and vehicle speed of the engine 10, a brake pedal 15b for braking the tractor 1, and a clutch pedal 15c for shutting off the clutch for power disconnection (not illustrated), a reverse lever (forward/reverse traveling switching operation unit) 15d for alternatively switching the traveling type of the tractor 1 among forward traveling, stopped traveling, and reverse traveling, and the like. In addition, a meter panel 16a is included in the front side of the driver's seat 14 as the display unit 16.

The brake pedal 15b, the clutch pedal 15c, and the reverse lever 15d constitute the operation unit 15 on which an operation for stopping traveling of the tractor 1 can be performed. The accelerator pedal 15a and the reverse lever 15d constitute the operation unit 15 on which an operation for starting traveling of the tractor 1 can be performed.

On the right side of the driver's seat 14, a main transmission lever 15e for increasing/decelerating the traveling speed of the tractor 1 as the operation unit 15, a monitor 16b as a display unit 16, and the like are included. The main transmission lever 15e includes a lifting switch 15f for lifting up and down the lifting device. By operating the lifting switch 15f to lift up the roll baler 2, it is possible to interrupt the pickup of straw grass by the roll baler 2, and by operating the lifting switch 15f to lift down the roll baler 2, it is possible to start the pickup of straw grass by the roll baler 2. In other words, the lifting switch 15f constitutes the operation unit 15 that can perform the pickup interruption operation for interrupting the pickup of straw grass and the pickup start operation for starting the pickup of straw grass.

Referring back to FIG. 1, the roll baler 2 includes a machine base 23 including a pair of right and left wheels 22. A baler unit 24 including a bale forming chamber 24A is mounted above the machine base 23. In front of the baler unit 24, a pickup unit 25 that picks up straw grass from a work place such as a field.

Inside the bale forming chamber 24A, an upper side conveyor 26 and a lower side conveyor 27 are arranged so as to face each other. The upper side conveyor 26 and the lower side conveyor 27 can compress straw grass while rotating same to form a bale.

The bale formed in the bale forming chamber 24A can be discharged from the bale forming chamber 24A by opening a discharge cover (not illustrated) that covers a discharge port on the rear side of the bale forming chamber 24A.

The upper side conveyor 26 includes, for example, a pair of right and left endless chains 26d stretched over between a drive sprocket 26a located in the front side of the bale forming chamber 24A and an idle sprocket 26b located in the rear side of the bale forming chamber 24A, and a number of bale forming pipes (not illustrated) stretched horizontally therebetween.

The lower side conveyor 27 includes, for example, a pair of right and left endless chains 27d stretched over between a drive sprocket 27a located in the rear side of the bale forming chamber 24A and an idle sprocket 27b located in the pickup unit 25 in the front side of the bale forming chamber 24A, and a number of bale forming pipes (not illustrated) stretched horizontally therebetween.

On the idle sprocket 27b located in the pickup unit 25, a pick-up blade 28 including many blade parts over substantially the entire width of the pickup unit 25 is fixed so as to rotate in synchronization. In other words, the pick-up blade 28 rotates in synchronization with the rotation of the idle sprocket 27b accompanying the rotational drive of the drive sprocket 27a, and picks up straw grass in a field, and takes up same into the bale forming chamber 24A.

As illustrated in FIG. 2, the roll baler 2 includes a control unit 29 that controls various operations, a communication unit 30 that can communicate with the tractor 1, and a bale detection unit 31 that detects the size of the bale formed in the bale forming chamber 24A, a load detection unit 32 that detects a pickup load of straw grass, and the like. The roll baler 2 is configured to determine, in the control unit 29, whether various deceleration controls described below are necessary, on the basis of the detection results of the bale detection unit 31 and the load detection unit 32, and send a deceleration command for causing the traveling control unit 17A of the tractor 1 to execute a deceleration control determined to be necessary, to the tractor 1 when it is determined that the deceleration control is necessary.

As illustrated in FIG. 1, the bale detection unit 31 is included outside the bale forming chamber 24A, and is configured to detect the size of a bale on the basis of the profile position of the bale formed in the bale forming chamber 24A. In the illustrated example, the bale detection unit 31 includes a swinging type bale-side swing member 31a that swings in the up and down direction, following the profile position of the bale that is formed in the bale forming chamber 24A, and a potentioswitch (not illustrated) that detects the swing angle of the bale-side swing member 31a.

The bale-side swing member 31a is disposed on both the right and left sides of the upper side conveyor 26, and is configured to swing along with the upper side conveyor 26 in the up and down direction, following the profile position of the bale. In the bale-side swing member 31a, the base end side which is a fixed end side is rotatably supported in the front side of the bale forming chamber 24A about a horizontal axis, and the tip side which is a free end side is disposed in the rear side of the bale forming chamber 24A in the state of freely supporting the idle sprocket 26b of the upper side conveyor 26. The bale-side swing member 31a is swingably biased downward by a biasing means such as a coil spring.

In addition to the above, various configurations capable of detecting the size of a bale forming the bale forming chamber 24A can be appropriately employed for the bale detection unit 31.

As illustrated in FIG. 1, the load detection unit 32 is included in the pickup unit 25, and configured to detect a pickup load on the basis of the bulk (cross-sectional area) of straw grass that passes through the carry-in route from the pickup unit 25 to the bale forming chamber 24A. In the illustrated example, the load detection unit 32 includes a swinging type load-side swing member 32a that swings in the up and down direction following the bulk of the straw grass that passes through the carry-in route, and a potentioswitch (not illustrated) that detects the swing angle of the load-side swing member 32a.

In the load-side swing member 32a, the base end side which is a fixed end side is rotatably supported by the pickup unit 25 about a horizontal axis in a posture in which the tip side that is a free end side extends rearward. The load-side swing member 32a is swingably biased downward by a biasing means such as a coil spring.

In addition to the above, various configurations capable of detecting a pickup load of straw grass can be appropriately employed for this load detection unit 32.

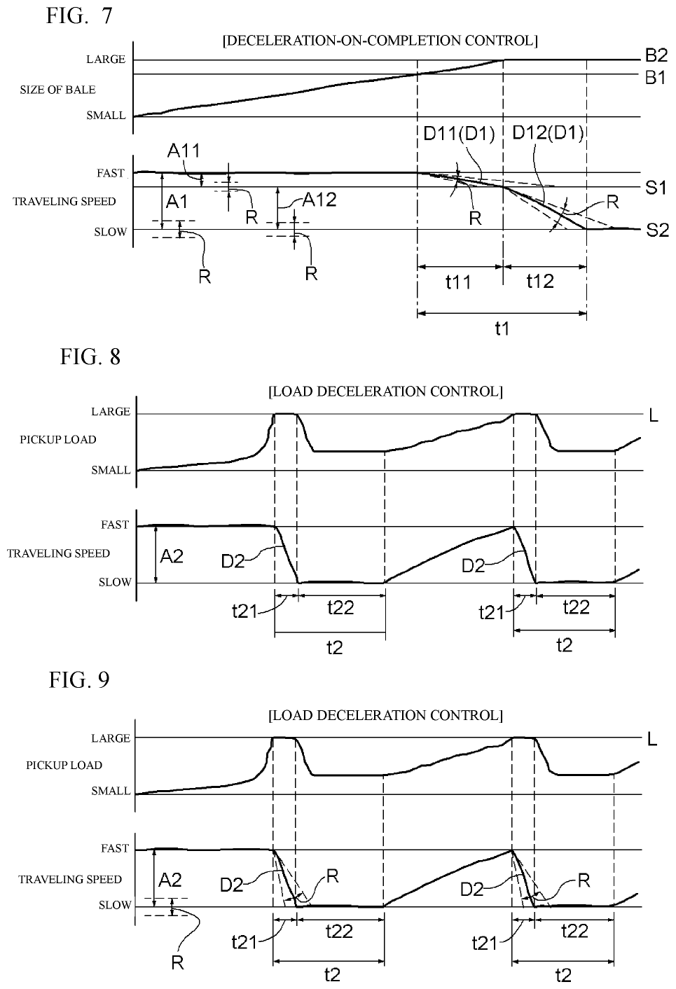

Moreover, in this work vehicle, as illustrated in FIG. 2, the traveling control unit 17A of the tractor 1 is configured to be able to execute a deceleration control that switches the transmission 19 to decelerate the traveling speed of the tractor 1 in response to the deceleration command based on the detection results of the bale detection unit 31 and the load detection unit 32 sent from the roll baler 2. Specifically, the traveling control unit 17A of the tractor 1 is configured to be able to execute, as the abovementioned deceleration control, a deceleration-on-completion control to decelerate the tractor 1 in response to the deceleration command sent from the roll baler 2 when the size of the bale detected by the bale detection unit 31 is equal to or larger than a first setting value B1 (see FIG. 6), and a load deceleration control to decelerate the tractor 1 in response to the deceleration command sent from the roll baler 2 when the pickup load detected by the load detection unit 32 is equal to or larger than a setting value (see FIG. 7). Although illustration is omitted, the operation unit 15 includes an operation switch capable of selecting whether the traveling control unit 17A executes the deceleration-on-completion control and the load deceleration control.

The traveling control unit 17A of the tractor 1 is configured to stop the traveling of the tractor 1 only when detecting that an operation for stopping traveling has been performed on the operation unit 15, and start the traveling of the tractor 1 only when detecting that an operation for starting traveling has been performed on the operation unit 15 in both cases where the deceleration-on-completion control is being executed or where the load deceleration control is being executed.

Therefore, the tractor 1 can be stopped only when the operator indicates the intention to stop the tractor 1 by performing the operation for stopping traveling on the operation unit 15 during the execution of the deceleration-on-completion control or the load deceleration control, and it is possible to prevent the tractor 1 from automatically stopping on a sloping ground or the like. In addition, the traveling of the tractor 1 can be restarted only when the operator indicates the intention to restart the tractor 1 by performing the operation for starting traveling on the operation unit 15, and it is possible to prevent a restart unexpected by the operator.

The deceleration-on-completion control and load deceleration control will be described in detail below.

First, the deceleration-on-completion control will be described.

FIG. 4 is a flowchart illustrating a control flow when the traveling control unit 17A of the tractor 1 executes the deceleration-on-completion control. FIG. 6 is a diagram illustrating the relation between the size of a bale and the traveling speed over time.

As illustrated in FIG. 4, in a case where the tractor 1 equipped with the roll baler 2 is traveling at a normal traveling speed for grass collecting work (for example, a constant speed of 10 km/h), when the size of the bale detected by the bale detection unit 31 reaches the first setting value B1 (for example, 80% of the size at the time of completion), the traveling control unit 17A of the tractor 1 executes the deceleration-on-completion control in response to the deceleration command sent from the roll baler 2 to decelerate the traveling speed of the tractor 1 at a deceleration for deceleration-on-completion D1 (see FIG. 6) (Yes in step #11, step #12). Here, deceleration is a concept that includes a deceleration amount and a deceleration rate. In the present embodiment, as illustrated in FIG. 6, as the deceleration for deceleration-on-completion D1, a deceleration amount for deceleration-on-completion is A1, and a deceleration rate for deceleration-on-completion is A1/t1 (t1 is the execution time of the deceleration-on-completion control). In addition, an indication indicating that the timing when the bale forming chamber 24A completes is close or the deceleration-on-completion control is being executed is displayed on the display unit 16 to notify the operator.

Specifically, as illustrated in FIG. 6, in the deceleration-on-completion control executed when the size of the bale detected by the bale detection unit 31 reaches the first setting value B1, the traveling control unit 17A of the tractor 1 decelerates the traveling speed of the tractor 1 down to a first target speed 51 (for example, 50% of the normal traveling speed for grass collecting work) at a first deceleration for deceleration-on-completion D11. As the first deceleration for deceleration-on-completion D11, a first deceleration amount for deceleration-on-completion is A11, and a first deceleration rate for deceleration-on-completion is A11/t11.

After that, when the size of the bale detected by the bale detection unit 31 reaches a second setting value B2 which exceeds the first setting value B1 (for example, the size at the time of completion), in response to the deceleration command sent from the roll baler 2, the traveling control unit 17A of the tractor 1 decelerates the traveling speed of the tractor 1 down to a second target speed S2 which is slower than the first target speed S1 (for example, 20% of the normal traveling speed for grass collecting work) at a second deceleration for deceleration-on-completion D12 with a greater deceleration than that of the first deceleration for deceleration-on-completion D11. As the second deceleration for deceleration-on-completion D12, a second deceleration amount for deceleration-on-completion is A12 (>A11), and a second deceleration rate for deceleration-on-completion is A12/t12 (>A11/t11).

By executing such a deceleration-on-completion control, the operator can perform a grass collecting work with high accuracy until the bale forming chamber 24A completes in a state where the traveling speed is reduced. It is also possible to suppress the loss of straw grass due to continued grass collecting work in a state where the bale forming chamber 24A has reached completion.

Here, the deceleration for deceleration-on-completion D1 (the first deceleration for deceleration-on-completion D11 and the second deceleration for deceleration-on-completion D12) is set to a relatively gentle deceleration that does not shake the operator's body. Therefore, the operator can smoothly operate the tractor 1 for grass collecting work even when the deceleration-on-completion control is executed.

The monitor 16b includes a deceleration amount adjustment operation unit X1 of a manually operated type such as a dial type (see FIG. 2) that can adjust a deceleration amount as a deceleration in a deceleration control (the deceleration-on-completion control and the load deceleration control) and a deceleration rate adjustment operation unit X2 of a manually operated type such as a dial type (see FIG. 2) that can adjust a deceleration rate (deceleration amount per unit time) as a deceleration in a deceleration control (the deceleration-on-completion control and the load deceleration control).

With regard to the deceleration for deceleration-on-completion D1 (the first deceleration for deceleration-on-completion D11 and the second deceleration for deceleration-on-completion D12), for example, it is set to an initial value in advance by an experiment or the like. The deceleration for deceleration-on-completion D1 (the first deceleration for deceleration-on-completion D11 and the second deceleration for deceleration-on-completion D12) that has been set is stored in the traveling control unit 17A or the like. In addition, the deceleration for deceleration-on-completion D1 (the first deceleration for deceleration-on-completion D11 and the second deceleration for deceleration-on-completion D12) can be adjusted from the initial value by an operator's adjustment operation (change operation) on the deceleration amount adjustment operation unit X1 (see FIG. 2) and the deceleration rate adjustment operation unit X2 (see FIG. 2).

Specifically, as illustrated in FIG. 7, the first deceleration amount for deceleration-on-completion (A11) and the first deceleration rate for deceleration-on-completion (A11/t11) as the first deceleration for deceleration-on-completion D11 and the second deceleration amount for deceleration-on-completion (A12) and the second deceleration rate for deceleration-on-completion (A12/t12) as the second deceleration for deceleration-on-completion D12 can be adjusted individually from the initial value within a predetermined range R indicated by the virtual line in FIG. 7 by the adjustment operation (change operation) on the deceleration amount adjustment operation unit X1 (see FIG. 2) and the deceleration rate adjustment operation unit X2 (see FIG. 2), and for example, can be adjusted in accordance with the performance and condition of the roll baler 2. With regard to the adjustment of the deceleration amount, in FIG. 7, the lower ends of the arrow indicating the deceleration amounts (A11, A12) indicate that the amount can be adjusted within the predetermined range R. By adjusting these, a deceleration amount for deceleration-on-completion (A1) as the deceleration for deceleration-on-completion D1 and a deceleration rate for deceleration-on-completion (A1/t1) can also be adjusted from the initial value within the predetermined range R.

Referring back to FIG. 4, when it is detected that the operation for stopping traveling has been performed on the operation unit 15 during the execution of the deceleration-on-completion control (Yes in step #13), the traveling control unit 17A of the tractor 1 stops the traveling of the tractor 1.

Then, if the operation for stopping traveling on the operation unit 15 described above is an operation for stopping traveling from switching the reverse lever 15d to stopped traveling, the traveling control unit 17A of the tractor 1 cancels the deceleration-on-completion control (Yes in step #14, step #15).

Therefore, when the tractor 1 is restarted afterwards, the operator can cause the tractor 1 to travel at a desired traveling speed without executing the deceleration-on-completion control, and, for example, it is possible to move the tractor 1 quickly from a place where a bale cannot be discharged, such as a sloping ground, to a place where the bale can be appropriately discharged.

Meanwhile, if the operation for stopping traveling on the operation unit 15 described above is not the operation from the reverse lever 15d but from the brake pedal 15b or the clutch pedal 15c, the traveling control unit 17A of the tractor 1 does not cancel and continues the deceleration-on-completion control (No in step #14, step #12). In this case, when detecting that the operation for starting traveling has been performed on the brake pedal 15b or the clutch pedal 15c, the traveling control unit 17A of the tractor 1 starts the traveling of the tractor 1 while the deceleration-on-completion control is maintained, and thus the operator can start a grass collecting work with the speed reduced from the beginning.

Although illustration is omitted, even if the operation for stopping traveling on the operation unit 15 is not the operation for stopping traveling from the reverse lever 15d, if it is subsequently detected that a bale has been discharged from the roll baler 2, the traveling control unit 17A of the tractor 1 cancels the deceleration-on-completion control. In other words, in the present embodiment, the condition for canceling the deceleration-on-completion control is set when detection of either that the operation for stopping traveling from switching the reverse lever 15d to stop traveling has been performed or that the bale has been discharged from the roll baler 2 is established.

Here, the deceleration-on-completion control can be temporarily canceled for the purpose of moving to a work place such as a field.

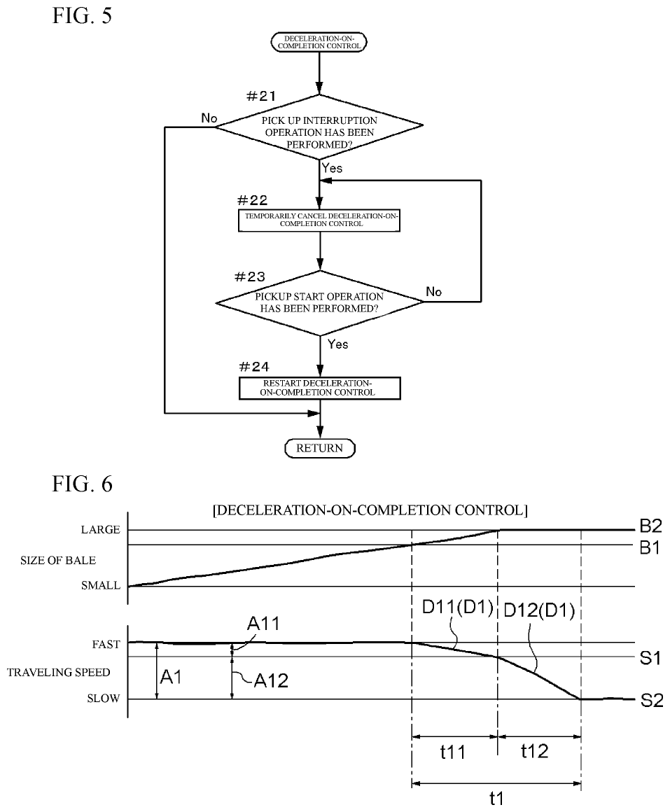

FIG. 5 is a flowchart illustrating the control flow when the traveling control unit 17A of the tractor 1 temporarily cancels the deceleration-on-completion control. As illustrated in FIG. 5, during the execution of the deceleration-on-completion control, when detecting that a pick up interruption operation for interrupting the pickup of straw grass has been performed on the operation unit 15 (lifting switch 15f), the traveling control unit 17A of the tractor 1 temporarily cancels the deceleration-on-completion control, and increases the traveling speed of the tractor 1 and restores the normal traveling speed for grass collecting work (Yes in step #21, step #22).

After that, when detecting that a pickup start operation for starting the pickup of straw grass has been performed on the operation unit 15 (lifting switch 15f), the traveling control unit 17A of the tractor 1 restarts the deceleration-on-completion control to decelerate the traveling speed of the tractor 1 again (Yes in step #23, step #24).

Therefore, the operator can temporarily cancel the deceleration-on-completion control at a current work place, for example, when the grass collecting work at the current work place is completed, and move the tractor 1 to the next work place at a desired traveling speed. Then, the operator can perform the grass collecting work at the next work place with the deceleration-on-completion control restarted.

Next, the load deceleration control will be further described.

FIG. 8 is a diagram illustrating the relation between the pickup load and the traveling speed over time. As illustrated in FIG. 8, when the pickup load detected by the load detection unit 32 is equal to or larger than a setting value L, the traveling control unit 17A of the tractor 1 executes the load deceleration control in response to the deceleration command sent from the roll baler 2 to decelerate the traveling speed of tractor 1 with a deceleration for load deceleration D2.

Specifically, in the load deceleration control that is executed when the pickup load detected by the load detection unit 32 reaches the setting value L, the traveling control unit 17A of the tractor 1 decelerates the traveling speed of the tractor 1 at the deceleration for load deceleration D2 greater than the deceleration for deceleration-on-completion D1 for a first setting time t21 (for example, 3 seconds), and then maintains the traveling speed after the deceleration for a second setting time t22 (for example, 10 seconds). As the deceleration for load deceleration D2, a deceleration amount for load deceleration is A2 (>A1), and a deceleration rate for load deceleration is A2/t21 (>A1/t1, A11/t11, A12/t12). Then, when the second setting time t22 elapses, the traveling control unit 17A of the tractor 1 cancels the load deceleration control and increases the traveling speed of the tractor 1 to restore the normal traveling speed for grass collecting work.

That is, in the present embodiment, the condition for canceling the load deceleration control is that a total time t2 of the first setting time t21 and the second setting time t22 elapses after the load deceleration control is executed. The condition for canceling the load deceleration may be, for example, that the pickup load detected by the load detection unit 32 is a setting value for cancelation, that is lower than the setting value L by a predetermined value.

Here, the deceleration for load deceleration D2 is larger than deceleration for deceleration-on-completion D1 (the first deceleration for deceleration-on-completion D11 and the second deceleration for deceleration-on-completion D12), and is set to a deceleration at which the amount of straw picked up into the bale forming chamber 24A can be sufficiently reduced. Therefore, by executing such a load deceleration control, it is possible to avoid in advance problems such as clogging of straw grass caused by exceeding the limit of the processing capacity of the roll baler 2.

The deceleration for load deceleration D2 is also set to an initial value in advance by, for example, an experiment or the like, and the set deceleration for load deceleration D2 is stored in the traveling control unit 17A and the like.

In addition, the deceleration for load deceleration D2 can also be adjusted from the initial value by the operator's adjustment operation (change operation) on the deceleration amount adjustment operation unit X1 (see FIG. 2) and the deceleration rate adjustment operation unit X2 (see FIG. 2).

As illustrated in FIG. 9, the deceleration amount for load deceleration (A2) and the deceleration rate for load deceleration (A2/t21) as the deceleration for load deceleration D2 can be adjusted individually from the initial value within a predetermined range R indicated by the virtual line in FIG. 9 by the adjustment operation (change operation) on the deceleration amount adjustment operation unit X1 (see FIG. 2) and the deceleration rate adjustment operation unit X2 (see FIG. 2), and for example, can be adjusted in accordance with the performance and condition of the roll baler 2. With regard to the adjustment of the deceleration amount, in FIG. 9, the lower end of the arrow indicating the deceleration amount (A2) indicates that the amount can be adjusted within the predetermined range R.

As described above, during the execution of the load deceleration control, the traveling control unit 17A of the tractor 1 stops the traveling of the tractor 1 only when detecting that the operation for stopping traveling has been performed on the operation unit 15. However, unlike during the execution of the deceleration-on-completion control, the traveling control unit 17A of the tractor 1 is configured not to cancel the load deceleration control even if the operation for stopping traveling is the operation for stopping traveling that switches the reverse lever 15d to stop traveling. Therefore, even when the tractor 1 is restarted after the traveling is stopped, the tractor 1 can travel in a state where the load deceleration control has been executed and the traveling speed is reduced, and it is possible to avoid problems such as clogging of straw grass on the roll baler 2 after the restart.

In the present embodiment, the traveling control unit 17A of the tractor 1 is configured to execute the load deceleration control with priority over the deceleration-on-completion control. Therefore, if the load deceleration control execution condition and the deceleration-on-completion control execution condition are fulfilled at the same time, the load deceleration control is executed preferentially to avoid problems such as clogging of straw grass on the roll baler 2.

Next, the display example of the display unit 16 of the tractor 1 will be described.

As described above, the meter panel 16a and the monitor 16b are included in the cabin 12 as the display unit 16, and in this tractor 1, the condition of the roll baler 2 and the execution status of the deceleration-on-completion control and the load deceleration control can be displayed on the display unit 16 as information related to grass collecting work.

Hereinafter, the display example of the display unit 16 will be described focusing on the content related to grass collecting work. The display control of the display unit 16 is executed by the control unit 17 and the like.

### When Executing Deceleration-on-Completion Control

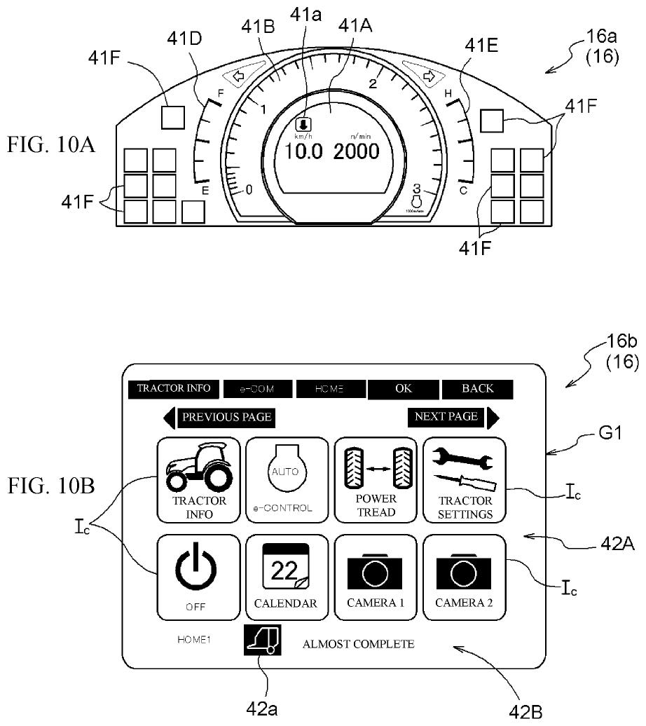

FIG. 10(a) illustrates the meter panel 16a as the display unit 16. In this meter panel 16a, a liquid crystal panel 41A that displays characters and figures is disposed in the central area, and an engine tachometer 41B that indicates the rotation speed of the engine 10 with a pointer is disposed in the outer circumference side of the liquid crystal panel 41A. A fuel gauge 41D that indicates a remaining fuel amount with a pointer is disposed on the left side of the engine tachometer 41B of the meter panel 16a, and a water temperature gauge 41E that indicates the cooling water temperature of the engine 10 with a pointer is disposed on the right side of the engine tachometer 41B. In addition, a plurality of display lamps 41F and the like that display and warn about the traveling system and work system are located in the right and left outer areas of the meter panel 16a. Under normal conditions, characters and the like indicating the vehicle speed and the rotation speed of the engine 10 are displayed in the upper area of the liquid crystal panel 41A.

FIG. 10(b) illustrates a menu screen G1 displayed on the monitor 16b as the display unit 16. In a central display area 42A of this menu screen G1, a plurality of icons Ic for instructing the transition to a tractor information screen for confirming tractor information, a setting screen for various settings of the tractor 1 and the monitor 16b, and the like are displayed. When the operator instructs the transition to a specific icon Ic by operating the operation unit (not illustrated) of the monitor 16b, the screen transitions to a screen corresponding to the icon Ic that instructed the transition.

When the deceleration-on-completion control is executed, as illustrated in FIG. 10(a), an indication 41a (downward arrow in the figure) indicating that the deceleration control is being performed is displayed at a position near above the character indication indicating the vehicle speed on the liquid crystal panel 41A of the meter panel 16a, and as illustrated in FIG. 10(b), an indication to make the operator to recognize that the roll baler 2 has almost reached completion, such as a graphical indication 42a indicating the roll baler 2 and a character indication of “Complete soon” in a lower display area 42B of the menu screen G1 displayed on the monitor 16b. Therefore, the operator can easily recognize that the roll baler 2 has almost reached completion and the vehicle speed is under deceleration control.

### When Discharging Bale

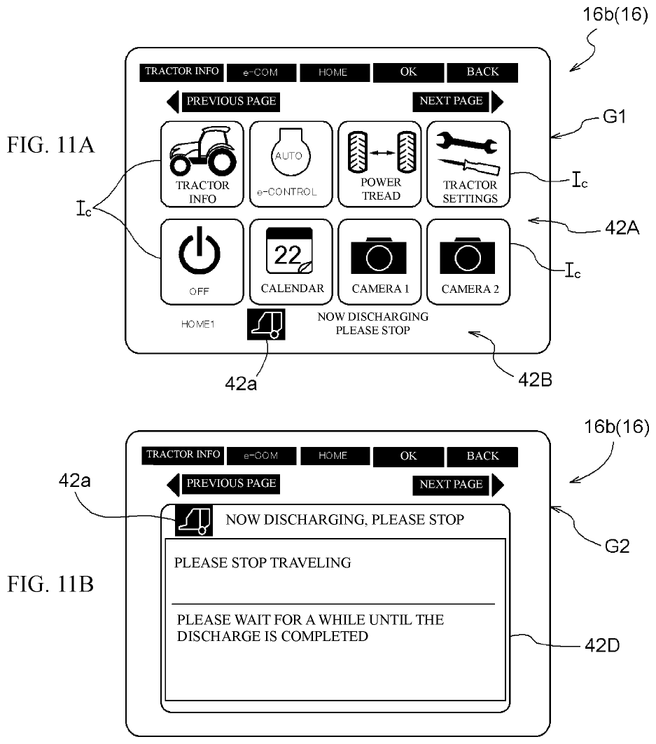

FIG. 11(a) illustrates the menu screen G1 displayed on the monitor 16b as the display unit 16. When discharging a roll-shaped bale from the roll baler 2, in the lower display area 42B of the menu screen G1, an indication to make the operator recognize that a bale is being discharged and to prompt the operator to stop the tractor 1, such as the graphical indication 42a indicating the roll baler 2 and a character indication of “Now discharging. Please stop” is displayed.

Here, when the operator selects the lower display area 42B by operating the operation unit of the monitor 16b, or the like, the screen transitions to a detail screen G2 illustrated in FIG. 11(b). At the top of a central display area 42D of this detail screen G2, as is the case with the menu screen G1, the graphical indication 42a indicating the roll baler 2 and a character indication of “Now discharging. Please stop” are displayed, and below that, displayed are an indication for prompting the operator to stop traveling, such as a character indication of “Please stop running” and an indication to prompt the operator to wait, such as a character indication of “Roll has reached completion. Please wait for a while until the discharge is completed.” Therefore, the operator can easily recognize that the roll baler 2 has reached completion and a bale is being discharged, and that it is necessary to stop the tractor 1 and wait for a while. cl When Executing Load Deceleration Control

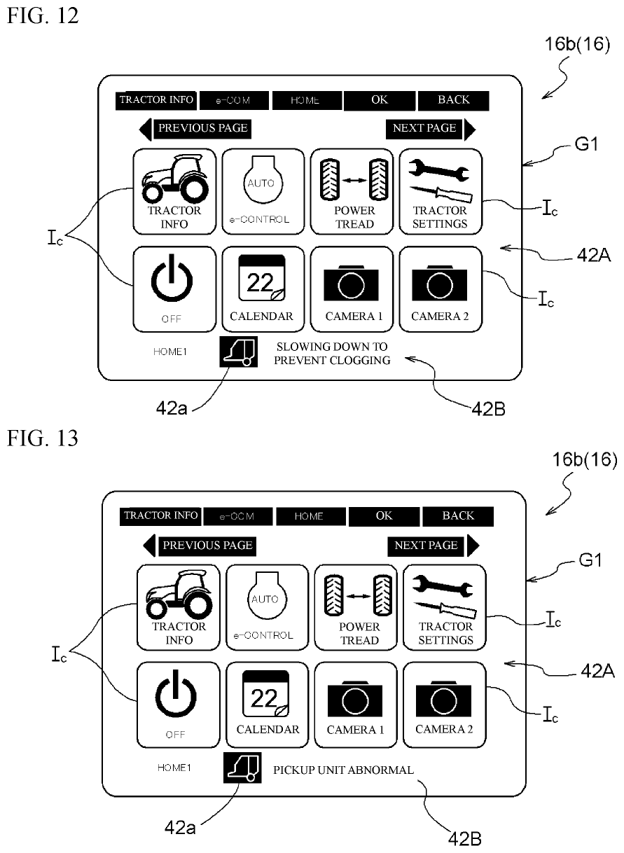

When the load deceleration control is executed, as is the case with the deceleration-on-completion control, as illustrated in FIG. 10(a), the indication 41a (downward arrow in the figure) indicating that the deceleration control is being performed is displayed at a position near above the character indication indicating the vehicle speed on a liquid crystal panel 19A of the meter panel 16a. Moreover, as illustrated in FIG. 12, in the lower display area 42B of the menu screen G1 displayed on the monitor 16b, an indication to make the operator to recognize that the vehicle is slowing down to prevent clogging, such as the graphical indication 42a indicating the roll baler 2 and a character indication of “Slowing down to prevent clogging” is displayed. Therefore, the operator can easily recognize that the vehicle speed is under deceleration control to prevent clogging.

### When Roll Baler Breaks Down

When a failure such as a breakdown occurs in the roll baler 2, as illustrated in FIG. 13, in the lower display area 42B of the menu screen G1 displayed on the monitor 16b, an indication for recognizing that there is a failure such as the breakdown of the roll baler 2, such as the graphical indication 42a indicating the roll baler 2 and a character indication of “Pickup unit abnormal” is displayed. This character indication is in accordance with the failure occurring on the roll baler 2, and depending on the failure occurring on the roll baler 2, a character indication such as “Pickup unit abnormal”, “Net abnormal”, “Transport abnormal”, or the like is displayed. Therefore, the operator can easily recognize that there is a failure such as the breakdown of the roll baler 2 and recognize the content of the failure such as a breakdown.

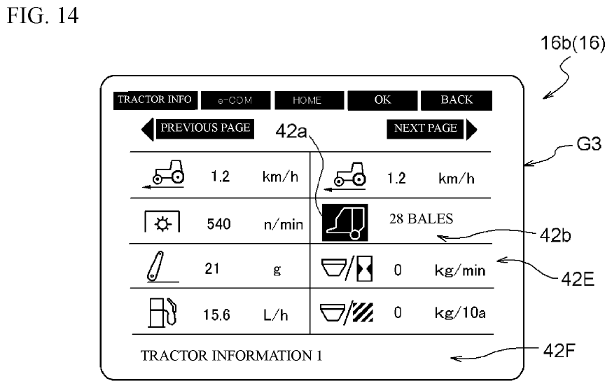

At the time of grass collecting work, by operating the operation unit of the monitor 16b, or the like, if a transition to the icon Ic (see FIG. 13) of the tractor information screen in the central display area 42A of the menu screen G1 is instructed, the screen transitions to a tractor information screen G3 illustrated in FIG. 14. In a central display area 42E of this tractor information screen G3, an indication indicating various information such as the fuel efficiency of the tractor 1 is displayed, and the graphical indication 42a indicating the roll baler 2 and a character indication 42b such as a numerical value indicating the total number of packaged balers (e.g., 28) are displayed side by side. Therefore, the operator can easily recognize the total number of packaged balers at the time of grass collecting work.

In the lower display area 42F of this information screen G3, various character indications that are displayed when the abovementioned deceleration-on-completion control is executed, when the baler is discharging, when the load deceleration control is executed, or when the roll baler 2 breaks down may be displayed.

[Other Embodiments]

(1) In the above-described embodiment, a case has been illustrated as an example, in which the traveling control unit 17A of the tractor 1 is configured to execute the deceleration control in response to the deceleration command based on the detection results of the bale detection unit 31 and the load detection unit 32 sent from the roll baler 2. However, the traveling control unit 17A of the tractor 1 may be configured to determine the necessity of deceleration control by itself on the basis of the detection results of the bale detection unit 31 and the load detection unit 32 sent from the roll baler 2, and execute a deceleration control determined to be necessary.

(2) In the above-described embodiment, a case has been illustrated as an example, in which the traveling control unit 17A of the tractor 1 is configured to decelerate the traveling speed of the tractor 1 down to the target speed at the deceleration for deceleration-on-completion D1 in the deceleration-on-completion control. However, the traveling control unit 17A of the tractor 1 may be configured to decelerate the traveling speed of the tractor 1 at the deceleration for deceleration-on-completion D1 for a setting time and maintain the traveling speed after the deceleration.

(3) In the above-mentioned embodiment, as the work vehicle that performs a grass collecting work, a type in which the traveling machine body is configured with the tractor 1 that is a separate body from the roll baler unit has been illustrated as an example. However, as a matter of course, a type in which the traveling machine body is configured integrally with the roll baler unit may be employed.

(4) In the above-described embodiment, a case where the operation unit 15 of a manually operated type is included in the traveling machine body (tractor 1) has been illustrated as an example. However, in addition to this, the operation unit 15 may be included in the roll baler unit (roll baler 2).

(5) In the above-described embodiment, a case has been illustrated as an example, in which the second deceleration for deceleration-on-completion D12 is set to be larger than the first deceleration for deceleration-on-completion D11 in the deceleration-on-completion control. However, the second deceleration for deceleration-on-completion D12 may be set to be the same as or smaller than the first deceleration for deceleration-on-completion D11.

(6) In the above-described embodiment, a case where both the deceleration amount and the deceleration rate are controlled as the deceleration (D1, D2) in the deceleration-on-completion control and the load deceleration control has been described as an example. However, only one of the deceleration amount and the deceleration rate may be controlled as the deceleration (D1, D2).

### INDUSTRIAL APPLICABILITY

The present invention can be applied to various work vehicles that perform a grass collecting work in which straw grass such as forage grass and straw scattered in a field is collected to form a roll-shaped bale.

### DESCRIPTION OF REFERENCE NUMERALS

1 tractor

2 roll baler (roll baler unit)

15 operation unit

17 traveling control unit

31 bale detection unit

32 load detection unit

B1 first setting value (setting value of the size of a bale)

D1 deceleration for deceleration-on-completion

D2 deceleration for load deceleration

L setting value (setting value of a pickup load)

1. A work vehicle comprising:
a traveling machine body capable of traveling by drive;
a roll baler unit configured to pick up straw grass and form a roll-shaped bale as the traveling machine body travels;
a bale detection unit configured to detect a size of the bale formed by the roll baler unit;
a load detection unit configured to detect a pickup load of straw grass in the roll baler unit; and
a traveling control unit capable of executing, as a deceleration control of the traveling machine body, a deceleration-on-completion control to decelerate the traveling machine body when the size of the bale detected by the bale detection unit is equal to or larger than a setting value, and a load deceleration control to decelerate the traveling machine body when the pickup load detected by the load detection unit is equal to or larger than a setting value,
wherein a deceleration in the load deceleration control is set to be larger than the deceleration in the deceleration-on-completion control.

2. The work vehicle according to claim 1, comprising:
an operation unit of a manually operated type; and
a notification unit configured to give notification when the deceleration control is executed,
wherein the traveling control unit stops traveling of the traveling machine body only when detecting that an operation for stopping traveling has been performed on the operation unit during execution of the deceleration control.

3. The work vehicle according to claim 2, wherein the traveling control unit starts the traveling of the traveling machine body only when detecting that an operation for starting traveling has been performed on the operation unit during stop of the traveling of the traveling machine body.

4. The work vehicle according to claim 1, comprising an operation unit of a manually operated type,
wherein the traveling control unit temporarily cancels the deceleration-on-completion control when detecting that a pickup interruption operation for interrupting pickup of the straw grass has been performed on the operation unit during execution of the deceleration-on-completion control, and then restarts the deceleration-on-completion control when detecting that a pickup start operation for starting the pickup of the straw grass has been performed on the operation unit.

5. The work vehicle according to claim 2, comprising, as the operation unit, a forward/reverse traveling switching operation unit capable of alternatively switching a traveling type of the traveling machine body among forward traveling, stopped traveling, and reverse traveling,
wherein the traveling control unit cancels the deceleration-on-completion control when detecting that the operation for stopping traveling has been performed on the forward/reverse traveling switching operation unit during execution of the deceleration-on-completion control.

6. The work vehicle according to claim 1, comprising a deceleration amount adjustment operation unit capable of adjusting a deceleration amount as the deceleration in the deceleration control.

7. The work vehicle according to claim 1, comprising a deceleration rate adjustment operation unit capable of adjusting a deceleration rate as the deceleration in the deceleration control.
